(19) United States
(12) Patent Application Publication
(10) Pub. No.: US 2016/0349924 A1
(43) Pub. Date: Dec. 1, 2016

(54) INFORMATION PROCESSING METHOD AND ELECTRONIC DEVICE

(71) Applicants: Beijing Lenovo Software Ltd., Beijing (CN); Lenovo (Beijing) Limited, Beijing (CN)

(72) Inventors: Fei Gao, Beijing (CN); Yu Chen, Beijing (CN)

(21) Appl. No.: 14/847,610

(22) Filed: Sep. 8, 2015

(30) Foreign Application Priority Data
May 28, 2015 (CN) 201510282364.8

(51) Int. Cl. G06F 3/042; H04N 9/31; G06F 3/16

(52) U.S. Cl. CPC G06F 3/0421; G06F 3/16; H04N 9/31

(57) ABSTRACT

The embodiments of the present disclosure disclose an information processing method, comprising: forming, by a projection unit of an electronic device, a first display area, the first display area being an area outside a display area of a display unit of the electronic device and having a first display content displayed therein; detecting, by a detection unit of the electronic device, a first operation on the first display content in the first display area; acquiring operation information corresponding to the first operation; and responding to the first operation and generating prompt information corresponding to the first operation based on the operation information. The embodiments of the present disclosure further disclose an electronic device.

### CROSS-REFERENCE TO RELATED APPLICATION(S)

This application claims priority to the Chinese Patent Application No. 201510282364.8, filed on May 28, 2015, which application is incorporated herein by reference in its entirety.

### TECHNICAL FIELD

The present disclosure relates to information processing technology, and in particular, to an information processing method and an electronic device.

### BACKGROUND

Currently, electronic devices having a projection function, especially smart mobile phones, tablet computers or the like, are increasingly popular with more and more users. However, the conventional electronic devices having a projection function generally have the following problems. For example, after a projection function of an electronic device is used to project a keyboard to a projection area outside a display area of the electronic device, when a user of the electronic device implements an input operation through the projected keyboard in the projection area, as there is no physical key in the projected keyboard, the user can only determine whether an input operation has been completed, whether the input operation is erroneously implemented or the like according to a display content in the display area of the electronic device, which reduces the user experience.

### SUMMARY

In order to solve the technical problem in the related art, embodiments of the present disclosure provide an information processing method and an electronic device.

The technical solutions according to the embodiments of the present disclosure are implemented as follows.

The embodiments of the present disclosure provide an information processing method, comprising: forming, by a projection unit of an electronic device, a first display area, the first display area being an area outside a display area of a display unit of the electronic device and having a first display content displayed therein; detecting, by a detection unit of the electronic device, a first operation on the first display content in the first display area; acquiring operation information corresponding to the first operation; and responding to the first operation and generating prompt information corresponding to the first operation based on the operation information.

The embodiments of the present disclosure further provide an electronic device, comprising: a projection component configured to form a first display area, the first display area being an area outside a display area of a display component of the electronic device and having a first display content displayed therein; a detection component configured to detect a first operation on the first display content in the first display area; a processor configured to acquire operation information corresponding to the first operation, and configured to respond to the first operation and generate prompt information corresponding to the first operation based on the operation information.

With the information processing method and electronic device according to the embodiments of the present disclosure, a first display area is formed by a projection unit of the electronic device, and a first operation relative to the first display content in the first display area is detected by a detection unit of the electronic device, to acquire operation information corresponding to the first operation, so as to respond to the first operation and generate prompt information corresponding to the first operation based on the operation information. Thereby, when an input operation is implemented by a user of the electronic device in the first display area projected by the projection unit, the user of the electronic device may be prompted of whether an input operation has been completed, whether an input is accurate or the like through prompt information corresponding to the operation, so as to improve the user experience. Further, with the embodiments of the present disclosure, even if an input operation is implemented by the user of the electronic device without a keyboard, the user of the electronic device may perceive the operation process through the prompt information corresponding to the operation, thereby improving the user experience.

### BRIEF DESCRIPTION OF THE DRAWINGS

FIG. 1 is a first diagram of a flowchart of implementing an information processing method according to an embodiment of the present disclosure.

FIG. 2 is a diagram of a positional relationship between a first display area and a display area of a display unit of an electronic device according to an embodiment of the present disclosure.

FIG. 3 is a second diagram of a flowchart of implementing an information processing method according to an embodiment of the present disclosure.

FIG. 4 is a first structural diagram of an electronic device according to an embodiment of the present disclosure.

FIG. 5 is a second structural diagram of an electronic device according to an embodiment of the present disclosure.

### DETAILED DESCRIPTION

The basic idea of the embodiments of the present disclosure is that a first display area is formed by a projection unit of an electronic device, the first display area being an area outside a display area of a display unit of the electronic device and having a first display content displayed therein; a first operation on the first display content in the first display area is detected by a detection unit of the electronic device; operation information corresponding to the first operation is acquired by the electronic device; and a response is made to the first operation and prompt information corresponding to the first operation is generated by the electronic device based on the operation information.

For more thoroughly understanding the features and technical contents of the present disclosure, the implementations of the present disclosure will be described below in detail in conjunction with accompanying drawings. The accompanying drawings are merely used for reference and illustration instead of limiting the present disclosure.

### First Embodiment

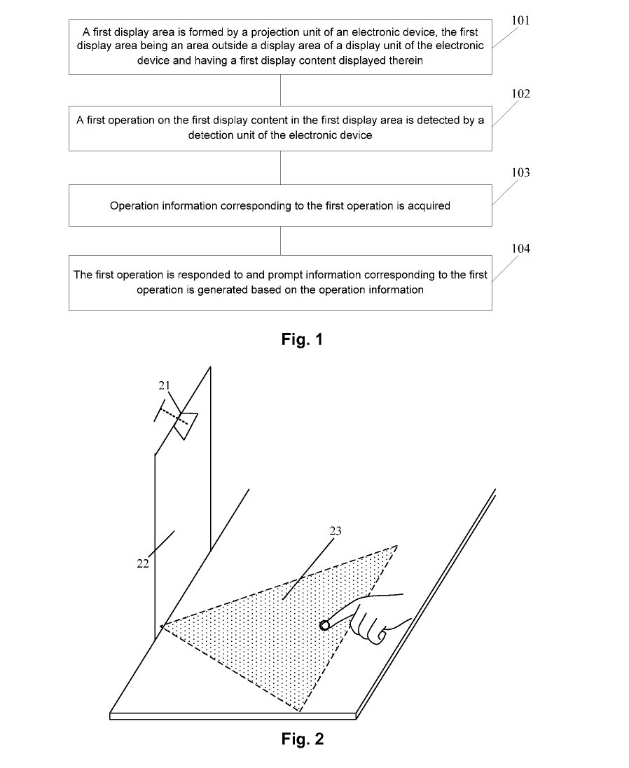

FIG. 1 is a first diagram of a flowchart of implementing an information processing method according to an embodiment of the present disclosure. As shown in FIG. 1, the method comprises the following steps.

In step 101, a first display area is formed by a projection unit of an electronic device. The first display area is an area outside a display area of a display unit of the electronic device and has a first display content displayed therein.

In the present embodiment, the electronic device may be any electronic device having a projection function such as a mobile phone, a tablet computer, a personal computer or the like.

As shown in FIG. 2, a first display area 23 is projected by a projection unit 21 of the electronic device. The first display area 23 is an area outside a display area 22 of a display unit of the electronic device. The first display area has a first display content displayed therein, and the display area of the display unit may have a second display content displayed therein. It should be noted here that a positional relationship between the first display area and the display area of the display unit of the electronic device illustrated in FIG. 2 is merely used to explain the embodiment of the present disclosure, and is not intended to limit the embodiment of the present disclosure. In practical applications, the positional relationship between the first display area and the display area of the display unit of the electronic device may be set randomly according to practical requirements.

In the present embodiment, the second display content may be the same as or different from the first display content.

In a specific embodiment, when the electronic device is in a first state, a second display content is presented in the display area of the display unit.

The second display content is the same as or different from the first display content. The first state represents that the display unit of the electronic device is in an activate state. For example, the second display content in the display area of the display unit is a first main interface, and the first display content in the first display area is two or more prompts, such as a keyboard. In this case, the first display content is different from the second display content. As another example, the second display content presented in the display area of the display unit is the same as the first display content presented in the first display area, i.e., both contents are the first main interface. Thus, when the first display content is the same as the second display content, the first display content corresponding to the projected first display area may be used in place of the second display content in the display area of the electronic device, so as to control the electronic device by implementing an operation on the first display content corresponding to the projected first display area, which improves the user experience; and when the first display content is different from the second display content, different application interfaces are presented with different display contents, which also improves the user experience.

In another specific embodiment, when the electronic device is in a second state, a first display content is displayed in the first display area. The second state represents that the display unit of the electronic device is in an inactive state, i.e., a black screen state. That is, when the display area of the display unit of the electronic device is in a black screen state, the first display content may still be displayed in the first display area, so that the cruise duration of the electronic device is extended without influencing an input operation.

In step 102, a first operation on the first display content in the first display area is detected by a detection unit of the electronic device.

In the present embodiment, the detection unit may specifically be an infrared detection unit, which may emit infrared light. A projection area of the infrared light may comprise the first display area projected by the projection unit. Thereby, when an operation body, such as a finger, touches the first display content in the first display area, the operation body may block a light path, and the infrared light may form a light spot on the fingertip. Then, the infrared detection unit may detect a first operation through the formed light spot, and acquire operation information of the first operation according to the first operation, which provides a basis for a subsequent response to the first operation.

In the present embodiment, the first operation may be a touch operation or two or more touch operations on the first display content which is implemented by an operation body.

In step 103, operation information corresponding to the first operation is acquired.

In the present embodiment, when the first operation is two or more touch operations on the first display content, the operation information may represent sub-operation information corresponding to each of the two or more touch operations. Correspondingly, the prompt information is generated once or is generated twice or more. That is, each touch operation may correspond to one generation operation of prompt information, or multiple touch operations may correspond to one generation operation of prompt information. Here, a correspondence relationship between a number of the touch operations and a number of times of the generation of the prompt information may be set randomly according to practical requirements.

In step 104, the first operation is responded to and prompt information corresponding to the first operation is generated based on the operation information.

In the present embodiment, the prompt information comprises at least audio information. Specifically, the prompt information comprises audio information, vibration information, light property change information or the like. For example, the light property change may specifically be a color change, an intensity change or the like of the light projected by the projection unit.

In the present embodiment, when the first display content is two or more prompts, different prompts may correspond to the same prompt information or different prompt information. For example, when different prompts correspond to different audio information, with the method according to the embodiment of the present disclosure, touch operations are implemented on the prompts in the first display content to achieve a purpose of playing music. As another example, when different prompts correspond to the same audio information, which may be a keyboard knocking sound, a user of the electronic device may determine whether an operation has been completed through the audio information or the like. Therefore, the embodiment of the present disclosure can expand the application range of the electronic device, and improve the user experience.

With the information processing method according to the embodiment of the present disclosure, a first display area is formed by a projection unit of an electronic device, and a first operation on the first display content in the first display area is detected by a detection unit of the electronic device, to acquire operation information corresponding to the first operation, so as to respond to the first operation and generate prompt information corresponding to the first operation based on the operation information. Thereby, when an input operation is implemented by a user of the electronic device in the first display area projected by the projection unit, the user of the electronic device may be prompted of whether an input operation has been completed, whether an input is accurate or the like through prompt information corresponding to the operation, so as to improve the user experience. Further, with the embodiment of the present disclosure, even if an input operation is implemented by the user of the electronic device without a keyboard, the user of the electronic device may perceive the operation process through the prompt information corresponding to the operation, thereby improving the user experience.

### Second Embodiment

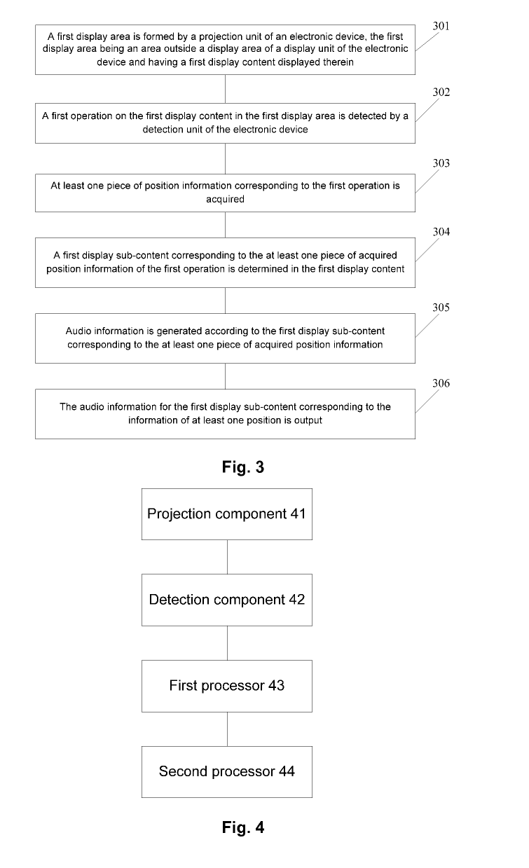

FIG. 3 is a second diagram of a flowchart of implementing an information processing method according to an embodiment of the present disclosure. As shown in FIG. 3, the method comprises the following steps.

In step 301, a first display area is formed by a projection unit of an electronic device. The first display area is an area outside a display area of a display unit of the electronic device and has a first display content displayed therein.

In the present embodiment, the electronic device may be any electronic device having a projection function such as a mobile phone, a tablet computer, a personal computer or the like.

As shown in FIG. 2, a first display area 23 is projected by a projection unit 21 of the electronic device. The first display area 23 is an area outside a display area 22 of a display unit of the electronic device. The first display area has a first display content displayed therein, and the display area of the display unit may have a second display content displayed therein. It should be noted here that a positional relationship between the first display area and the display area of the display unit of the electronic device illustrated in FIG. 2 is merely used to explain the embodiment of the present disclosure, and is not intended to limit the embodiment of the present disclosure. In practical applications, the positional relationship between the first display area and the display area of the display unit of the electronic device may be set randomly according to practical requirements.

In the present embodiment, the second display content may be the same as or different from the first display content.

In a specific embodiment, when the electronic device is in a first state, a second display content is presented in the display area of the display unit. The second display content is the same as or different from the first display content. The first state represents that the display unit of the electronic device is in an activate state. For example, the second display content in the display area of the display unit is a first main interface, and the first display content in the first display area is two or more prompts, such as a keyboard. In this case, the first display content is different from the second display content. As another example, the second display content presented in the display area of the display unit is the same as the first display content presented in the first display area, i.e., both contents are the first main interface. Thus, when the first display content is the same as the second display content, the first display content corresponding to the projected first display area may be used in place of the second display content in the display area of the electronic device, so as to control the electronic device by implementing an operation on the first display content corresponding to the projected first display area, which improves the user experience; and when the first display content is different from the second display content, different application interfaces are presented with different display contents, which also improves the user experience.

In another specific embodiment, when the electronic device is in a second state, a first display content is displayed in the first display area. The second state represents that the display unit of the electronic device is in an inactive state, i.e., a black screen state. That is, when the display area of the display unit of the electronic device is in a black screen state, the first display content may still be displayed in the first display area, so that the cruise duration of the electronic device is extended without influencing an input operation.

In step 302, a first operation on the first display content in the first display area is detected by a detection unit of the electronic device.

In the present embodiment, the detection unit may specifically be an infrared detection unit, which may emit infrared light. A projection area of the infrared light may comprise the first display area projected by the projection unit. Thereby, when an operation body, such as a finger, touches the first display content in the first display area, the operation body may block a light path, and the infrared light may form a light spot on the fingertip. Then, the infrared detection unit may detect a first operation through the formed light spot, and acquire operation information of the first operation according to the first operation, which provides a basis for a subsequent response to the first operation.

In the present embodiment, the first operation may be a touch operation or two or more touch operations on the first display content which is implemented by an operation body.

In step 303, at least one piece of position information corresponding to the first operation is acquired.

In the present embodiment, when the first operation is two or more touch operations on the first display content, the operation information may represent sub-operation information corresponding to each of the two or more touch operations. Specifically, the operation information may represent position information corresponding to each of the two or more touch operations.

Correspondingly, the audio information is generated once or is generated twice or more. That is, each touch operation may correspond to one generation operation of audio information, or multiple touch operations may correspond to one generation operation of audio information. Here, a correspondence relationship between a number of the touch operations and a number of times of the generation of the audio information may be set randomly according to practical requirements.

In step 304, a first display sub-content corresponding to the at least one piece of acquired position information of the first operation is determined in the first display content.

In step 305, audio information is generated according to the first display sub-content corresponding to the at least one piece of acquired position information.

In the present embodiment, each touch operation on the first display content corresponds to one piece of position information, and a first display sub-content corresponding to the position information of each touch operation is determined according to the position information, so as to determine the audio information according to the first display sub-content.

In step 306, the audio information for the first display sub-content corresponding to the at least one piece of position information is output.

In the present embodiment, when the first display content comprises two or more first display sub-contents, i.e., two or more prompts, different prompts may correspond to the same audio information or different audio information. For example, when different prompts correspond to different audio information, with the method according to the embodiment of the present disclosure, touch operations are implemented on the prompts in the first display content to achieve a purpose of playing music. As another example, when different prompts correspond to the same audio information, which may be a keyboard knocking sound, a user of the electronic device may determine whether an operation has been completed through the audio information or the like. Therefore, the embodiment of the present disclosure can expand the application range of the electronic device, and improve the user experience.

With the information processing method according to the embodiment of the present disclosure, a first display area is formed by a projection unit of an electronic device, and a first operation on the first display content in the first display area is detected by a detection unit of the electronic device, to acquire at least one piece of position information corresponding to the first operation, so as to determine a first display sub-content corresponding to the at least one piece of acquired position information of the first operation, generate audio information according to the first display sub-content corresponding to the at least one piece of acquired position information, and output the audio information. Thereby, when an input operation is implemented by a user of the electronic device in the first display area projected by the projection unit, the user of the electronic device may be prompted of whether an input operation has been completed, whether an input is accurate or the like through audio information corresponding to the operation, so as to improve the user experience. Further, with the embodiment of the present disclosure, even if an input operation is implemented by the user of the electronic device without a keyboard, the user of the electronic device may perceive the operation process through the audio information corresponding to the operation, thereby improving the user experience.

### Third Embodiment

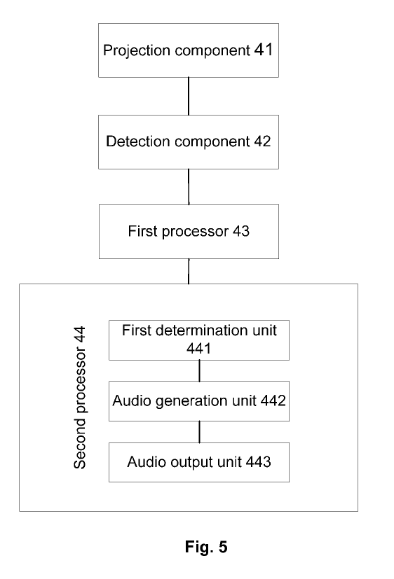

FIG. 4 is a first structural diagram of an electronic device according to an embodiment of the present disclosure. As shown in FIG. 4, the electronic device comprises: a projection component 41 configured to form a first display area, the first display area being an area outside a display area of a display component of the electronic device and having a first display content displayed therein; a detection component 42 configured to detect a first operation on the first display content in the first display area; a first processor 43 configured to acquire operation information corresponding to the first operation; and a second processor 44 configured to respond to the first operation and generate prompt information corresponding to the first operation based on the operation information.

In the present embodiment, the projection component, the detection component, and the display component correspond to the projection unit, the detection unit, and the display unit in the information processing method according to the embodiment described above respectively.

Those skilled in the art should understand that the functions of various processing components in the electronic device according to the embodiment of the present disclosure can be known with reference to the related description of the information processing method described above, and the various processing components in the electronic device according to the embodiment of the present disclosure can be implemented through analog circuits having functions described in the embodiment of the present disclosure or can be implemented by executing software having the functions described in the embodiment of the present disclosure on a smart terminal.

### Fourth Embodiment

Based on the electronic device according to the third embodiment, in the embodiment of the present disclosure, the prompt information comprises at least audio information. The first processor 43 is further configured to acquire at least one piece of position information corresponding to the first operation. The display area of the display component of the electronic device may have a second display content displayed therein. The second display content is different from the first display content.

### Fifth Embodiment

FIG. 5 is a second structural diagram of an electronic device according to an embodiment of the present disclosure. As shown in FIG. 5, the electronic device comprises: a projection component 41 configured to form a first display area, the first display area being an area outside a display area of a display component of the electronic device and having a first display content displayed therein; a detection component 42 configured to detect a first operation on the first display content in the first display area; a first processor 43 configured to acquire operation information corresponding to the first operation; and a second processor 44 configured to respond to the first operation and generate prompt information corresponding to the first operation based on the operation information.

In the present embodiment, the projection component, the detection component, and the display component correspond to the projection unit, the detection unit, and the display unit in the information processing method according to the embodiment described above respectively.

In the present embodiment, the prompt information comprises at least audio information. The first processor 43 is further configured to acquire at least one piece of position information corresponding to the first operation. The display area of the display component of the electronic device may have a second display content displayed therein. The second display content is different from the first display content.

In the present embodiment, the second processor 44 comprises: a first determination unit 441 configured to determine, in the first display content, a first display sub-content corresponding to the at least one piece of acquired position information of the first operation; an audio generation unit 442 configured to generate audio information according to the first display sub-content corresponding to the at least one piece of acquired position information; and an audio output unit 443 configured to output the audio information for the first display sub-content corresponding to the at least one piece of position information.

Those skilled in the art should understand that the functions of various processing components in the electronic device according to the embodiment of the present disclosure can be known with reference to the related description of the information processing method described above, and the various processing components in the electronic device according to the embodiment of the present disclosure can be implemented through analog circuits having functions described in the embodiment of the present disclosure or can be implemented by executing software having the functions described in the embodiment of the present disclosure on a smart terminal.

It should be understood that the devices and methods disclosed in the embodiments of the present disclosure may be implemented in other manners. The device embodiments as described above are merely illustrative. For example, the division of the units or components is merely a logically functional division, and in practice, there may be other division manners. For example, multiple units or components may be combined or may be integrated into another system, or some features may be ignored or may not be implemented. In addition, various constituent parts, which are displayed or discussed as being coupled or communicatively connected directly, may also be coupled or communicatively connected indirectly via some interfaces, devices or units in an electrical manner, a mechanical manner, or other manners.

The above units described as separate components may be or may not be separated physically. The components displayed as units may be or may not be physical units, i.e., they may be located in a place or may also be distributed among multiple network units. A part or all of the units may be selected as needed to achieve the purpose of the solutions of the present disclosure.

In addition, various functional units or components according to the embodiments of the present disclosure may all be integrated into a processing unit or component, or various units or components may be used separately, or two or more units or components are integrated into a unit or component. The above integrated units or components may be implemented by hardware or by hardware and software functional units.

A person having ordinary skill in the art can understand that all or a part of steps for implementing the above method embodiments may be implemented by programs instructing related hardware. The programs may be stored in a computer readable storage medium. When the programs are executed, the steps of the above method embodiments are implemented. The storage medium may be a medium which can store program codes, such as a mobile storage device, a Read-Only Memory (ROM), a Random Access Memory (RAM), a disk, or a disc etc.

Alternatively, the integrated unit or component according to the present disclosure may also be stored in a computer readable storage medium when it is implemented in a form of software functional module and is sold or used as an independent product. Based on this understanding, the substance of the technical solutions according to the embodiments of the present disclosure or portions of the technical solutions which contribute to the related art may be embodied in a form of software product. The computer software product is stored in a storage medium, including a number of instructions to enable a computer device (which may be a personal computer, a server, or a network device or the like) to perform all or a part of the methods according to various embodiments of the present disclosure. The storage medium described above may be a medium which can store program codes, such as a mobile storage device, a Read-Only Memory (ROM), a Random Access Memory (RAM), a disk, or a disc or the like.

The above description is merely specific embodiments of the present disclosure, and the scope of the present disclosure is not limited thereto. Changes or substitutions, which can be obviously envisaged by those skilled persons in the art, should be included in the scope of the present disclosure without departing the scope defined by the appended claims.

I/we claim:

1. An information processing method, comprising:
forming, by a projection unit of an electronic device, a first display area, the first display area being an area outside a display area of a display unit of the electronic device and having a first display content displayed therein;
detecting, by a detection unit of the electronic device, a first operation on the first display content in the first display area;
acquiring operation information corresponding to the first operation; and
responding to the first operation and generating prompt information corresponding to the first operation based on the operation information.

2. The method according to claim 1, wherein the prompt information comprises at least audio information.

3. The method according to claim 1, wherein the acquiring of operation information corresponding to the first operation comprises:
acquiring at least one piece of position information corresponding to the first operation.

4. The method according to claim 3, wherein the responding to the first operation and the generating of prompt information corresponding to the first operation based on the operation information comprises:
determining, in the first display content, a first display sub-content corresponding to the at least one piece of acquired position information of the first operation;
generating audio information according to the first display sub-content corresponding to the at least one piece of acquired position information; and
outputting the audio information for the first display sub-content corresponding to the at least one piece of position information.

5. The method according to claim 1, wherein the display area of the display unit can have a second display content displayed therein, the second display content being different from the first display content.

6. An electronic device, comprising:
a projection component configured to form a first display area, the first display area being an area outside a display area of a display component of the electronic device and having a first display content displayed therein;
a detection component configured to detect a first operation on the first display content in the first display area;
a processor configured to acquire operation information corresponding to the first operation; and configured to respond to the first operation and generate prompt information corresponding to the first operation based on the operation information.

7. The electronic device according to claim 6, wherein the prompt information comprises at least audio information.

8. The electronic device according to claim 6, wherein the processor is further configured to acquire at least one piece of position information corresponding to the first operation.

9. The electronic device according to claim 8, wherein the processor comprises:
a first determination unit configured to determine, in the first display content, a first display sub-content corresponding to the at least one piece of acquired position information of the first operation;
an audio generation unit configured to generate audio information according to the first display sub-content corresponding to the at least one piece of acquired position information; and
an audio output unit configured to output the audio information for the first display sub-content corresponding to the at least one piece of position information.

10. The electronic device according to claim 6, wherein the display area of the display component of the electronic device can have a second display content displayed therein, the second display content being different from the first display content.
